(19) United States
(12) Patent Application Publication
(10) Pub. No.: US 2026/0109334 A1
(43) Pub. Date: Apr. 23, 2026

(54) BRAKE CONTROL APPARATUS FOR A VEHICLE AIR BRAKE SYSTEM AND METHODS THEREFOR

(71) Applicant: Bendix Commercial Vehicle Systems LLC, Avon, OH (US)

(72) Inventors: Ryan S. Hurley, Lakewood, OH (US); Randy J. Salvatora, Columbia Station, OH (US); Thomas J. Hayes, Lakewood, OH (US)

(21) Appl. No.: 18/919,583

(22) Filed: Oct. 18, 2024

(51) Int. Cl. B60T 17/22; B60Q 5/00; B60T 7/16; B60T 13/68

(52) U.S. Cl. CPC B60T 17/22; B60Q 5/005; B60T 7/16; B60T 13/683

(57) ABSTRACT

A brake control apparatus is provided for a vehicle air braking system having an alerting device and brakes that are controllable from a remote location. The vehicle air brake apparatus comprises a controlling device arranged to (i) activate the alerting device to provide a first alert signal in response to receiving a brake request signal from the remote location to apply vehicle brakes and thereby to indicate receipt of the brake request signal from the remote location, and (ii) allow the alerting device to provide a cessation of the first alert signal after parking brakes have been applied and the vehicle has been brought to a stop and thereby to indicate that the vehicle is stopped and parked.

### BACKGROUND

The present application relates to vehicle air braking systems, and is particularly directed to a brake control apparatus for a vehicle air brake system and methods therefor, such as for a vehicle air brake system of a vehicle train having a tractor that is towing a number of trailers.

In some known vehicle trains, the vehicle air brake system has a capability to respond to a stop request signal from a remote location (i.e., away from the vehicle train) to apply brakes of the vehicle air brake system. The brakes may comprise either service brakes or parking brakes, or both, of the vehicle air brake system. When the service brakes are applied, the moving vehicle train is brought to a stop. When the parking brakes are applied, the stopped vehicle train is prevented from movement. The vehicle air brake system may also have a capability to respond to a release request signal from the remote location to release the parking brakes.

Despite advances already made, those skilled in the art continue with research and development efforts in the field of vehicle air braking systems.

### SUMMARY

In accordance with one embodiment, a brake control apparatus is provided for a vehicle air braking system having an alerting device and brakes that are controllable from a remote location. The vehicle air brake apparatus comprises a controlling device arranged to (i) activate the alerting device to provide a first alert signal in response to receiving a brake request signal from the remote location to apply vehicle brakes and thereby to indicate receipt of the brake request signal from the remote location, and (ii) allow the alerting device to provide a cessation of the first alert signal after parking brakes have been applied and the vehicle has been brought to a stop and thereby to indicate that the vehicle is stopped and parked.

In accordance with another embodiment, a brake control apparatus is provided for a vehicle air brake system having an air horn and brakes that are controllable from a remote location. The brake control apparatus comprises an energizeable solenoid valve for, when energized in response to a brake request signal from the remote location to apply the vehicle brakes, activating the air horn to provide an audible signal level to indicate receipt of the brake request signal from the remote location. The audible signal level diminishes to a non-audible signal level to indicate that the vehicle is stopped and parked.

In accordance with yet another embodiment, a brake control apparatus is provided for a vehicle air braking system having an alerting device and brakes that are controllable from a remote location. The brake control apparatus comprise means for activating the alerting device to provide an audible alarm in response to receiving a brake request signal from the remote location to apply the vehicle brakes. The audible alarm is diminished to non-audible after the vehicle brakes have been applied and the vehicle has been brought to a stop.

In accordance with still another embodiment, a method is provided of operating a vehicle air braking system. The method comprises receiving a brake request signal from a remote location to apply brakes of the vehicle. The method also comprises activating a pressure-responsive device on the vehicle to provide an audible signal to indicate that the brake request signal has been received. The method further comprises allowing the pressure-responsive device to continue providing the audible signal until an inaudible signal is provided to indicate that the vehicle has been parked in response to the brake request signal from the remote location.

### BRIEF DESCRIPTION OF THE DRAWINGS

FIG. 1 is an overhead pictorial diagram of a tractor of a vehicle train embodying a prior art tractor braking system.

FIG. 1A is a schematic block diagram of the prior art tractor braking system of FIG. 1.

FIG. 2 is similar to FIG. 1, and showing an overhead pictorial diagram of a tractor of a vehicle train embodying an example tractor braking system in accordance with the present disclosure.

FIG. 2A is similar to FIG. 1A, and showing a schematic block diagram of the tractor braking system of FIG. 2 embodying an example brake control apparatus in accordance with the present disclosure.

FIG. 2B is similar to FIG. 2A, and showing parts in different positions.

FIG. 3 is a flow diagram depicting a method of operating a vehicle air braking system in accordance with an embodiment.

FIG. 4 is a flow diagram depicting a method of operating a vehicle air braking system in accordance with another embodiment.

### DETAILED DESCRIPTION

The present application is directed to a brake control apparatus for a vehicle air braking system and methods therefor, such as for a vehicle air braking system of a single straight truck or a vehicle train having a tractor towing a number of trailers. The specific construction of the brake control apparatus may vary. It is to be understood that the disclosure below provides a number of embodiments or examples for implementing different features of various embodiments. Specific examples of components and arrangements are described to simplify the present disclosure. These are merely examples and are not intended to be limiting.

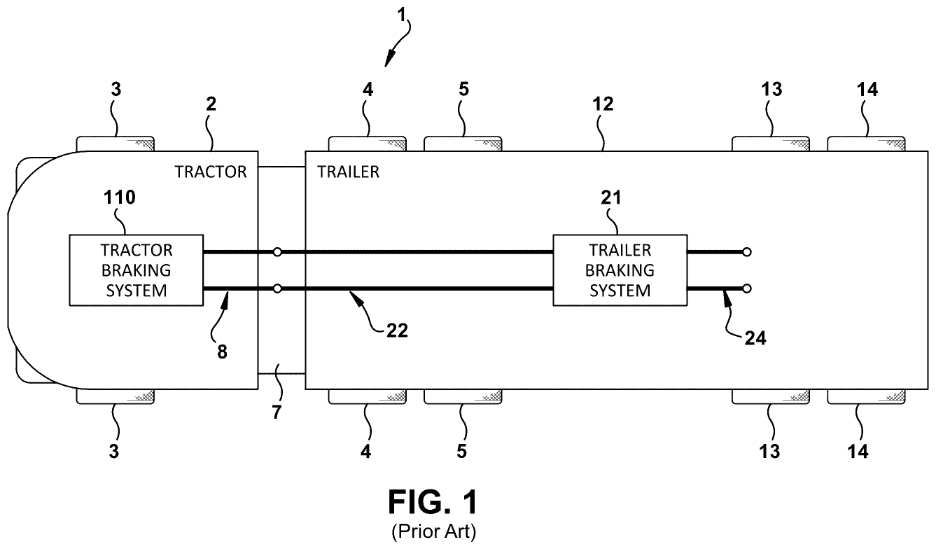

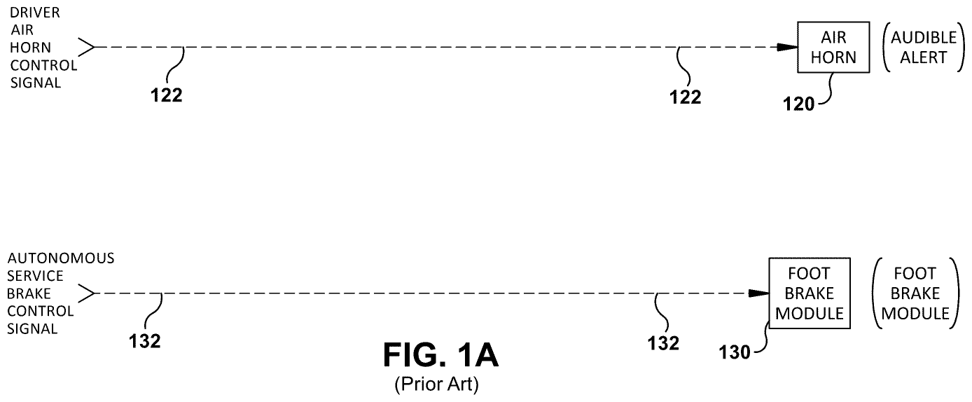

Referring to FIG. 1, an overhead pictorial diagram is illustrated of a tractor 2 of a vehicle train 1 embodying a prior art tractor braking system 110. Tractor 2 has three wheel axles 3, 4, 5, and a fifth wheel coupling platform 7 that is mechanically coupled to a trailer 12 that has two wheel axles 13, 14. The mechanically coupling of the trailer 12 to the fifth wheel coupling platform 7 is known and conventional and, therefore, will not be described.

Tractor 2 provides electrical power to trailer 12. Tractor braking system 110 is pneumatically connected to a trailer braking system 21 via tractor gladhands 8 that are connected with front gladhands 22 of the trailer 12. Trailer 12 also has rear gladhands 24 that are connectable to a braking system (not shown) of another towable vehicle (e.g., a dolly converter or another trailer). For simplicity and purpose of explanation, only one towable vehicle (i.e., the trailer 12) and, therefore, only one trailer braking system (i.e., the trailer braking system 21) is shown in FIG. 1. Structure and operation of gladhands of vehicle train 1 are known and conventional and, therefore, will not be described.

Referring to FIG. 1A, a schematic block diagram is illustrated of the prior art tractor braking system 110 of FIG. 1. In FIG. 1A, pneumatic line connections are shown as dashed lines, and electrical line connections are shown as solid lines.

As shown in FIG. 1A, an air horn 120 is responsive to a driver air horn control signal on line 122 to provide an audible alert (e.g., an alarm). The driver air horn control signal on line 122 can be provided in response to either a remote signal or a driver in the vehicle cab-compartment operating a switch.

Foot brake module 130 is responsive to an autonomous service brake control signal on line 132 to control service brakes of the vehicle. The autonomous service brake control signal on line 132 can be provided in response to either a remote signal or a driver in the vehicle cab-compartment operating a switch.

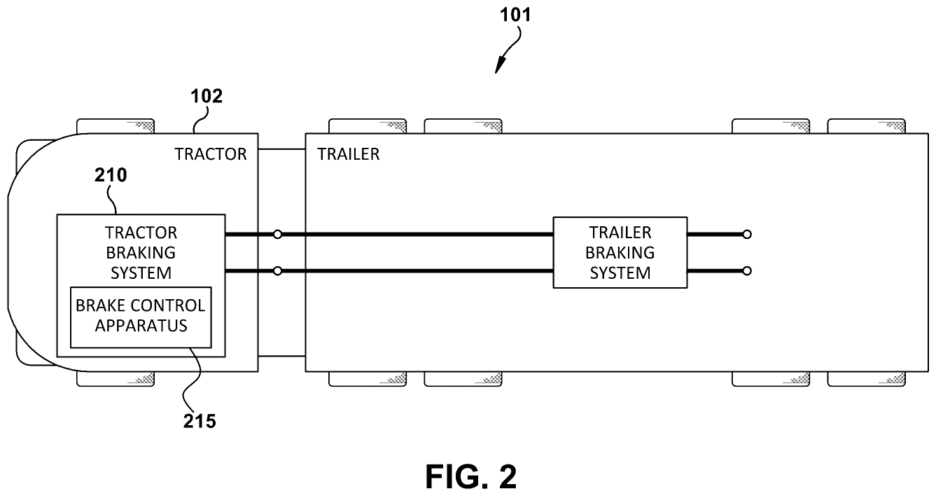

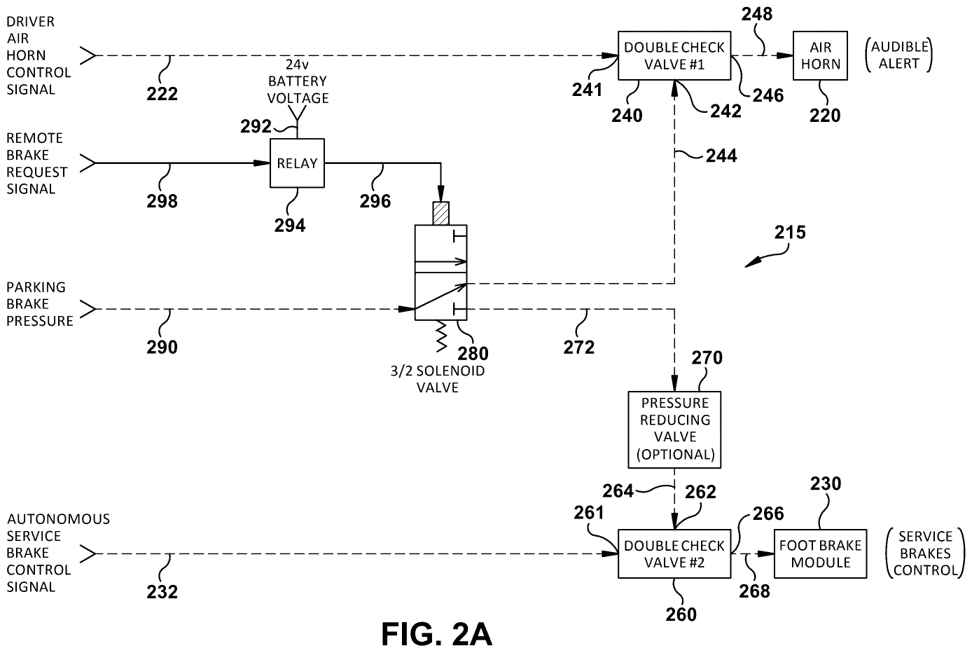

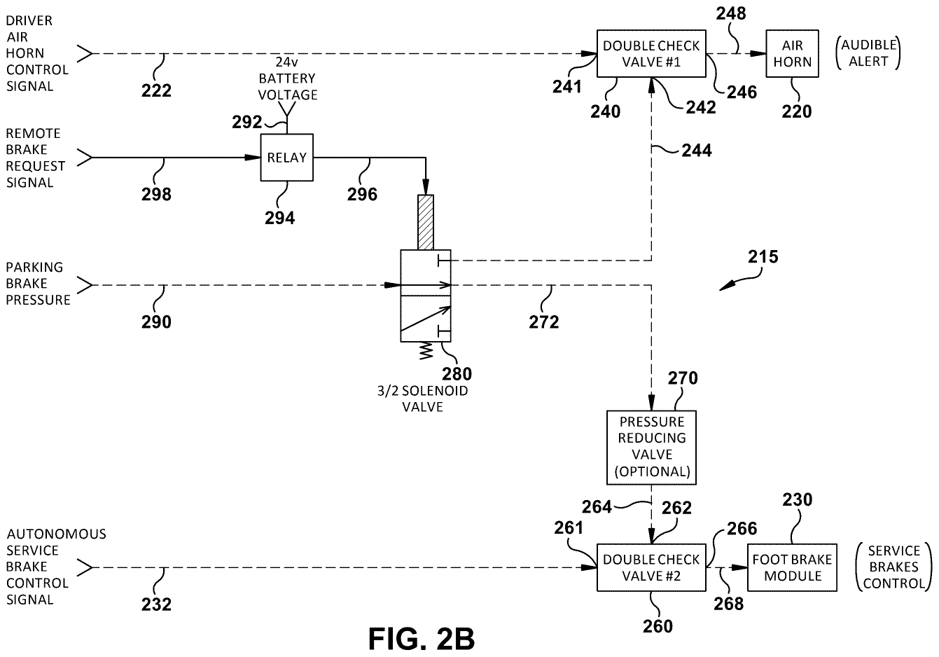

Referring to FIG. 2, an overhead pictorial diagram is illustrated of a tractor 102 of a vehicle train 101 embodying an example tractor braking system 210 in accordance with the present disclosure. FIG. 2A is similar to FIG. 1A, and shows a schematic block diagram of the tractor braking system 210 embodying an example brake control apparatus 215 in accordance with the present disclosure. Tractor braking system 210 shown in FIG. 2A is similar to trailer braking system 110 shown in FIG. 1A. As such, like components are illustrated in FIG. 2A with like reference numerals 100 higher than shown in FIG. 1A.

As shown in the brake control apparatus 215 of FIG. 2A, a first double check valve 240 receives at a supply port 241 a driver air horn control signal on line 222. The first double check valve 240 also receives at another supply port 242 the pneumatic pressure on line 244 from an energizeable solenoid valve 280. First double check valve 240 selects the higher of the two pressures on line 222 and line 244, and delivers the selected pressure at a delivery port 246 on line 248 to an air horn 220 (i.e., an alerting device). Structure and operation of the first double check valve 240 are known and conventional and, therefore, will not be described. An example double check valve is model number DC-4, commercially available from Bendix Commercial Vehicle Systems LLC, located in Avon, Ohio.

The air horn 220 provides a first alert signal when a pneumatic pressure of at least a first predetermined pressure is applied to the air horn 220, and provides a second alert signal, which is a cessation of the first alert signal, when the applied pneumatic pressure to the air horn 220 drops below a second predetermined pressure. During cessation of the first alert signal, the second alert signal diminishes and becomes silent (e.g., the air horn 220 makes no sound). The first predetermined pressure may be between about above 100 pounds-per-square-inch (psi) and about 130 psi, and the second predetermined pressure may be between about 20 psi and about 45 psi. Depending upon truck model and governor setting, these ranges may change.

Although the above-description describes the air horn 220 as an alerting device, it is conceivable that the alerting device includes an orifice that provides the first alert signal when a pneumatic pressure of at least the first predetermined pressure is applied to the orifice, and provides the second alert signal when the applied pneumatic pressure to the orifice drops below the second predetermined pressure. The orifice can be tuned to throttle and pull air out based upon atmospheric conditions and thereby optimize the air flow rate through the orifice.

A second double check valve 260 receives at a supply port 261 an autonomous service brake control signal on line 232. The second double check valve 260 also receives at another supply port 262 the pneumatic pressure on line 264. The second double check valve 260 selects the higher of the two pressures on line 232 and line 264, and delivers the selected pressure at a delivery port 266 on line 268 to foot brake module 230. Structure and operation of the second double check valve 260 are known and conventional and, therefore, will not be described. An example double check valve is model number DC-4, commercially available from Bendix Commercial Vehicle Systems LLC, located in Avon, Ohio.

An optional pressure-reducing valve 270 is connected in line 264 between the supply port 262 of the second double check valve 260 and line 272 from the solenoid valve 280. The pressure-reducing valve 270 reduces the pressure in line 272 from the solenoid valve 280 to the second double check valve 260 on line 264. The pressure-reducing valve 270 can be selected based upon the level of brake force desired. Structure and operation of pressure-reducing valves are known and conventional and, therefore, will not be described.

Solenoid valve 280 is a 3/2 (i.e., 3-port/2-position) solenoid valve that is shown unenergized in FIG. 2A and energized in FIG. 2B. Structure and operation of the solenoid valve 280 are known and conventional and, therefore, will not be described. An example solenoid valve is model number AT-3, commercially available from Bendix Commercial Vehicle Systems LLC, located in Avon, Ohio.

The solenoid valve 280 is responsive (i.e., energizeable) to a 24V battery signal on line 292 being applied through an actuatable relay 294 to line 296 which, in turn, is applied to the solenoid valve 280. The relay 294 is an off-the-shelf relay, and is actuated in response to receiving a remote brake request signal on line 298. The remote brake request signal on line 298 may be transmitted from any external system located remote from the vehicle.

The relay 294 is electrically coupled between the solenoid valve 280 and the brake request signal on line 298 from the remote location. The relay 294 allows the 24V battery voltage on line 292 to be applied to the solenoid valve 280 when the relay 294 is actuated in response to the brake request signal on line 298 from the remote location. The solenoid valve 280 then allows parking brake pressure on line 290 to be removed from line 244 to the air horn 220 and thereby to activate the air horn 220 when the solenoid valve 280 is energized in response to the 24V battery voltage from the relay 294, as will be described herein.

Although the above description describes the battery voltage on line 292 as being 24V, it is conceivable that a different battery voltage (e.g., a 12V battery voltage) can be used and, therefore, a corresponding different solenoid valve would need to be used.

When the solenoid valve 280 is unenergized as shown in FIG. 2A, parking brake pressure on line 290 passes through the solenoid valve 280 to line 244 to the first double check valve 240. The parking brake pressure on line 290 may be plumbed into any location within the conventional parking brake circuit of the vehicle. When the solenoid valve 280 is energized as shown in FIG. 2B, the parking brake pressure on line 290 passes through the solenoid valve 280 to line 272, and then through the optional pressure reducing valve 270 to the second double check valve 260 on line 264.

During normal vehicle operation (i.e., no remote brake request signal is received on line 298), the solenoid valve 280 is unenergized as shown in FIG. 2A and the parking brake pressure on line 290 passes through the solenoid valve 280 and applied to the first double check valve 240. The parking brake pressure on line 290 is at a sufficient level such that the first double check valve 240 selects this pressure to be applied to the air horn 220, and the air horn 220 is silent (i.e., there is no audible alarm).

In accordance with an aspect of the present disclosure, when a remote brake request signal is received on line 298 (e.g., during an emergency stop scenario), the solenoid valve 280 is energized and moves from its unenergized position shown in FIG. 2A to its energized position shown in FIG. 2B. Notably, when the solenoid valve 280 is energized as shown in FIG. 2B, the parking brake pressure on line 290 passes through the solenoid valve 280 and the optional pressure-reducing valve 270 to the second double check valve 260. The parking brake pressure on line 290 is at a sufficient level such that the second double check valve 260 selects this pressure to be applied to the foot brake module 230 and thereby to apply the service brakes of the vehicle.

At the same time that the service brakes are being applied, the air horn 220 is activated to provide an audible alarm as a result of the solenoid valve 280 being energized and the subsequent loss of the parking brake pressure on line 244 being applied to the first double check valve 240. The audible alarm provided by the air horn 220 acts as a first indicator signal that the remote brake request signal on line 290 has been received.

The service brakes of the vehicle continue to be applied and the air horn 220 continues to provide the audible alarm until air reservoirs (not shown) of the vehicle are drained. When the air reservoirs of the vehicle are drained, the parking brakes of the vehicle are applied in a known manner, the service brakes are released, and the air horn 220 is no longer activated and becomes silent. The silencing of the air horn 220 is a cessation of the audible alarm, and acts as a second indicator signal that the vehicle is completely stopped and the parking brakes have been applied.

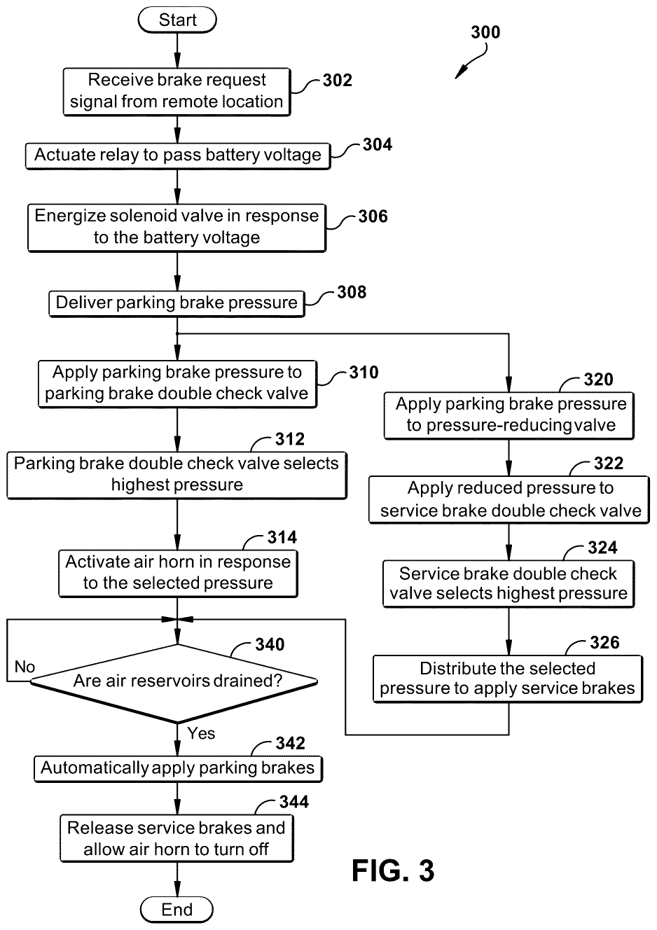

Referring to FIG. 3, a flow diagram 300 depicts a method of operating a vehicle air braking system. In block 302, a brake request signal is received from a remote location. Then in block 304, a relay (e.g., the relay 294 shown in FIGS. 2A and 2B) is actuated to pass a battery voltage. In block 306, a solenoid valve (e.g., the solenoid valve 280) is energized in response to the battery voltage. The process proceeds to block 308.

In block 308, a parking brake pressure is delivered through the solenoid valve. The parking brake pressure is applied to a parking brake double check valve (e.g., the first double check valve 240), as shown in block 310. The parking brake double check valve selects the parking brake pressure, as shown in block 312, and activates an air horn (e.g., the air horn 220) in response to the selected pressure, as shown in block 314. The process then proceeds to block 340.

At the same time the parking brake pressure is being delivered through the solenoid valve in block 308, the parking brake pressure is applied to an optional pressure-reducing valve, as shown in block 320. Then in block 322, a reduced parking brake pressure is applied to a service brake double check valve (e.g., the second double check valve 260). In block 324, the service brake double check valve selects the reduced parking brake pressure, since it is the highest available pressure. The selected, reduced parking brake pressure is distributed within the service brakes system to apply the service brakes of the vehicle to stop the vehicle, as shown in block 326. The process then proceeds to block 340.

In block 340, a determination is made as to whether air reservoirs of the vehicle are drained. If the determination in block 340 is negative (i.e., the air reservoirs are not drained), the process loops back upon itself to continue monitoring if the air reservoirs are drained to the point where the mechanical parking brakes are applied (e.g., less than 30 psi). If the determination is affirmative (i.e., the air reservoirs are drained), the process proceeds to block 342. In block 342, the parking brakes of the vehicle are automatically applied in a known manner. Then in block 344, the service brakes of the vehicle are released and the air horn turns off as a result of the air reservoirs being drained. The process then ends.

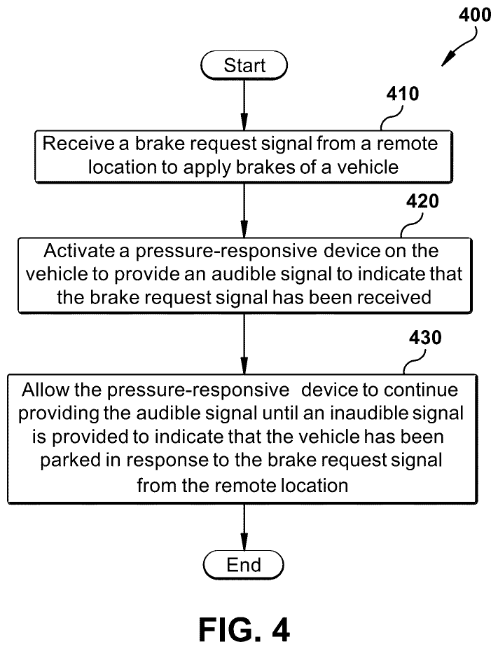

Referring to FIG. 4, a flow diagram 400 depicts a method of operating a vehicle air braking system in accordance with another embodiment. In block 410, a brake request signal is received from a remote location to apply brakes of a vehicle. The process proceeds to block 420 in which a pressure-responsive device (e.g., the air horn 220) on the vehicle is activated to provide an audible signal to indicate that the brake request signal has been received. Then in block 430, the pressure-responsive device is allowed to continue providing the audible signal until an inaudible signal (e.g., no sound from the air horn 220) is provided to indicate that the vehicle has been parked in response to the brake request signal from the remote location. The process then ends.

In some embodiments, a parking brake pressure of the vehicle is applied to the pressure-responsive device to provide the audible signal to indicate that the brake request signal has been received.

In some embodiments, air from the pressure-responsive device is exhausted to atmosphere.

In some embodiments, the method further comprises applying a battery voltage to the pressure-responsive device after the brake request signal is received from the remote location to apply the vehicle brakes.

It should be apparent that the brake control apparatus 215 including the solenoid valve 280 acts as a controlling device to provide a first alert signal (e.g., an audible signal level) in response to receiving the brake request signal on line 298 from the remote location to apply vehicle brakes and thereby to indicate receipt of the brake request signal from the remote location, and then a second alert signal (e.g., a diminished or non-audible signal level) after parking brakes have been applied and the vehicle has been brought to a stop and thereby to indicate that the vehicle is stopped and parked.

It should also be apparent that the brake control apparatus 215 enables service brakes of the vehicle to be applied to the tractor 102 as well any vehicle towed by the tractor 102, and then parking brakes of the vehicle to be subsequently applied in response to the brake request signal on line 298 that is received from the remote location.

It should further be apparent that means is provided for activating an alerting device to provide an audible alarm in response to receiving the brake request signal on line 298 from the remote location to apply vehicle brakes, wherein the audible alarm is diminished to non-audible after parking brakes have been applied and the vehicle has been brought to a stop. The alerting device may comprise the air horn 220 shown in FIGS. 2A and 2B that provides the audible alarm when a pneumatic pressure of at least a first predetermined pressure is applied to the air horn 220, and provides the non-audible when the applied pneumatic pressure to the air horn 220 drops below a second predetermined pressure.

Aspects of disclosed embodiments may be implemented in software, hardware, firmware, or a combination thereof. The various elements of the system, either individually or in combination, may be implemented as a computer program product tangibly embodied in a machine-readable storage device for execution by a processor. Various steps of embodiments may be performed by a computer processor executing a program tangibly embodied on a computer-readable medium to perform functions by operating on input and generating output. The computer-readable medium may be, for example, a memory, a transportable medium such as a compact disk or a flash drive, such that a computer program embodying aspects of the disclosed embodiments can be loaded onto a computer.

Although the above description describes use of only one solenoid valve and two double check valves, it is conceivable that any number of solenoid valves and double check valves may be used. Moreover, it is conceivable that any type of solenoid valve and any type of double check valve may be used.

While the present invention has been illustrated by the description of example processes and system components, and while the various processes and components have been described in detail, applicant does not intend to restrict or in any way limit the scope of the appended claims to such detail. Additional modifications will also readily appear to those skilled in the art. The invention in its broadest aspects is therefore not limited to the specific details, implementations, or illustrative examples shown and described. Accordingly, departures may be made from such details without departing from the spirit or scope of applicant's general inventive concept.

What is claimed is:

1. A brake control apparatus for a vehicle air braking system having an alerting device and brakes that are controllable from a remote location, the vehicle air brake apparatus comprising:
a controlling device arranged to (i) activate the alerting device to provide a first alert signal in response to receiving a brake request signal from the remote location to apply vehicle brakes and thereby to indicate receipt of the brake request signal from the remote location, and (ii) allow the alerting device to provide a cessation of the first alert signal after parking brakes have been applied and the vehicle has been brought to a stop and thereby to indicate that the vehicle is stopped and parked.

2. A brake control apparatus according to claim 1, wherein the alerting device includes an air horn that provides the first alert signal when a pneumatic pressure of at least a first predetermined pressure is applied to the air horn, and provides a second alert signal when the applied pneumatic pressure to the air horn drops below a second predetermined pressure.

3. A brake control apparatus according to claim 2, wherein the first alert signal comprises an audible signal, and the second alert signal comprises cessation of the audible signal after the audible signal has been provided in response to the brake request signal from the remote location.

4. A brake control apparatus according to claim 2, wherein the alerting device includes an orifice that provides the first alert signal when a pneumatic pressure of at least a first predetermined pressure is applied to the orifice, and provides the second alert signal when the applied pneumatic pressure to the orifice drops below a second predetermined pressure.

5. A brake control apparatus according to claim 1, wherein the controlling device includes an energizeable solenoid valve that is coupled between the alerting device and the brake request signal from the remote location.

6. A brake control apparatus according to claim 5 further comprising:
a double check valve associated with parking brakes of the vehicle, wherein the double check valve is pneumatically coupled between the solenoid valve and the alerting device.

7. A brake control apparatus according to claim 6, wherein (i) the controlling device includes an actuatable relay that is electrically coupled between the solenoid valve and the brake request signal from the remote location, (ii) the relay allows a battery voltage to be applied to the solenoid valve when the relay is energized in response to the brake request signal from the remote location, and (iii) the solenoid valve allows a parking brake pressure to be applied to the alerting device to activate the alerting device when the solenoid valve is energized in response to the battery voltage from the relay.

8. A brake control apparatus according to claim 5 further comprising:
a double check valve associated with service brakes of the vehicle; and
a pressure-reducing valve disposed in a pneumatic line that interconnects the solenoid valve and the double check valve associated with service brakes of the vehicle.

9. A brake control apparatus for a vehicle air brake system having an air horn and brakes that are controllable from a remote location, the brake control apparatus comprising:
an energizeable solenoid valve for, when energized in response to a brake request signal from the remote location to apply the vehicle brakes, activating the air horn to provide an audible signal level to indicate receipt of the brake request signal from the remote location, wherein the audible signal level diminishes to a non-audible signal level to indicate that the vehicle is stopped and parked.

10. A brake control apparatus according to claim 9, wherein the air horn provides the audible signal level when a pneumatic pressure of at least a first predetermined pressure is applied to the air horn, and provides the non-audible signal level when the applied pneumatic pressure to the air horn drops below a second predetermined pressure.

11. A brake control apparatus according to claim 10, wherein the first predetermined pressure is between about above 100 psi and about 130 psi, and the second predetermined pressure is between about 20 psi and about 45 psi.

12. A brake control apparatus according to claim 9, wherein the energizeable solenoid valve includes a 3/2 solenoid that is coupled between the air horn and the brake request signal from the remote location.

13. A brake control apparatus for a vehicle air braking system having an alerting device and brakes that are controllable from a remote location, the brake control apparatus comprising:
means for activating the alerting device to provide an audible alarm in response to receiving a brake request signal from the remote location to apply vehicle brakes, wherein the audible alarm is diminished to non-audible after parking brakes have been applied and the vehicle has been brought to a stop.

14. A brake control apparatus according to claim 13, wherein the alerting device includes an air horn that provides the audible alarm when a pneumatic pressure of at least a first predetermined pressure is applied to the air horn, and provides the non-audible when the applied pneumatic pressure to the air horn drops below a second predetermined pressure.

15. A brake control apparatus according to claim 13, wherein the alerting device includes an orifice that provides the audible alarm when a pneumatic pressure of at least a first predetermined pressure is applied to the orifice, and provides the non-audible when the applied pneumatic pressure to the orifice drops below a second predetermined pressure.

16. A brake control apparatus according to claim 13, wherein the activating means includes an energizeable 3/2 solenoid valve that is coupled between the alerting device and the brake request signal from the remote location.

17. A method of operating a vehicle air braking system, the method comprising:
receiving a brake request signal from a remote location to apply brakes of the vehicle;
activating a pressure-responsive device on the vehicle to provide an audible signal to indicate that the brake request signal has been received; and
allowing the pressure-responsive device to continue providing the audible signal until an inaudible signal is provided to indicate that the vehicle has been parked in response to the brake request signal from the remote location.

18. A method according to claim 17, wherein activating a pressure-responsive device on the vehicle to provide an audible signal to indicate that the brake request signal has been received includes:
applying a parking brake pressure of the vehicle to the pressure-responsive device to provide the audible signal to indicate that the brake request signal has been received.

19. A method according to claim 17, wherein allowing the pressure-responsive device to continue providing the audible signal until an inaudible signal is provided to indicate that the vehicle has been parked in response to the brake request signal from the remote location includes:
exhausting air from the pressure-responsive device to atmosphere.

20. A method according to claim 17 further comprising:
applying a battery voltage to the pressure-responsive device after the brake request signal is received from the remote location to apply the vehicle brakes.
